(19) United States
(12) Patent Application Publication
(10) Pub. No.: US 2008/0209673 A1
(43) Pub. Date: Sep. 4, 2008

(54) Caster and system for mobile device

(76) Inventors: Rory A. Cooper, Gibsonia, PA (US); Andrew M. Kwarciak, Saxonburg, PA (US); Mark A. McCartney, Chatham, NJ (US)

Correspondence Address: MEYER UNKOVIC & SCOTT LLP, 1300 OLIVER BUILDING, PITTSBURGH, PA, 15222, US

(21) Appl. No.: 12/070,939

(22) Filed: Feb. 22, 2008

Related U.S. Application Data
(60) Provisional application No. 60/903,256, filed on Feb. 23, 2007.

(51) Int. Cl. B60B 33/00

(52) U.S. Cl. 16/45

(57) ABSTRACT

An improved caster comprising a caster mount attachable to a frame of a mobile device, caster stem attached to the caster mount and operable to attach to a caster fork and wheel assembly, and a biasing means operable to restrict the rotation of the caster stem and thereby to prevent caster drift and flutter and to promote tracking of the mobile device. The biasing means can be in manner whereby the caster stem has at least one vertical notch defined therein and the biasing means comprises a spring plunger located in the caster mount. The spring plunger has an internal spring and a movable ball member attached to the spring and which faces the caster stem whereby the ball is biased against the caster stem and situated within the caster stem notch when the caster stem is in a desired rotational position. The biasing means can also employ magnets located in the caster stem and caster mount which align at opposite attracting poles when the caster is in a desired position.

### PRIORITY

This application hereby claims priority to provisional patent application Ser. No. 60/903,256, filed on Feb. 23, 2007.

### STATEMENT OF FEDERAL FUNDING

The United States government has rights to this invention, pursuant to Grant Number B3142C, through the Department of Veteran Affairs.

### FIELD OF THE INVENTION

This invention relates generally to a caster and caster system for a mobile device and more particularly relates to an improved caster and caster system which prevents caster drift and flutter and otherwise promotes tracking while a mobile device is traversing a side-sloped surface.

### BACKGROUND OF THE INVENTION

Wheelchair users constantly encounter difficulties while traversing various terrains during their daily activities. One specific problem a wheelchair user faces is caster drift while traversing side-sloped surfaces. As the wheelchair moves across a side-sloped surface, caster wheels tend to rotate down the slope (see e.g., FIG. 1). The user's downward limb must work very hard to keep the wheelchair climbing the incline or merely traveling straight across the side-sloped surface. This can result in pain or injury to the overworked limb.

It is advantageous to eliminate the great force the user must exert on his or her downward limb for safety reasons. One particular design created for such purposes is U.S. Pat. No. 6,607,250, entitled “Caster block and wheel lock for wheelchair”. This reference features a locking mechanism that can be used to eliminate caster wheel rotation. Once engaged, this device locks the caster in the trailing position and fixes the path of the wheelchair. Although this system prevents caster drift, it also severely limits the viability of the caster for indoor use, on uneven surfaces, or in any condition under which regular turning is required. In contrast, the caster and caster system of the present invention allows users to turn the wheelchair or other device and make changes to the path of travel, while the caster is engaged and while still preventing caster drift (see, e.g. FIG. 2, where the path of a device using the caster and caster system of the present invention does not follow the slope).

Outside of the wheelchair realm, delivery persons and others using carts and dollies frequently encounter trouble turning or navigating the related art devices, especially if the devices are heavily loaded. Further, because of caster drift, materials can fall off of the cart or dolly while the user is attempting to maintain a straight course on a sloped surface.

Additionally, consumers frequently encounter wheel flutter in shopping carts because the current caster stems are freely rotating and somewhat loose fitting within the caster mount. This wheel flutter causes the entire cart to shake and/or become difficult to navigate.

The present invention overcomes the disadvantages of the related art as discussed in detail below.

### SUMMARY OF THE INVENTION

An object of the caster and caster system of the present invention is to reduce the risk of upper limb pain and injury to wheelchair users by decreasing the forces required to traverse a side-sloped surface. The present invention further prevents caster drift and wheel flutter, by applying a forward or rearward biasing force on the caster wheel, thus lowering the forces required by the downhill limb to maintain a straight path.

Another object of the present invention is to provide a caster biasing mechanism or means that can be retrofitted to an existing caster system of a mobile device such as a wheelchair, cart, shopping cart, or dolly.

Additionally, the caster fork and wheel of the present invention rotate to allow a user to steer the wheelchair, cart, shopping cart, dolly or other mobile device, when necessary, and provide users with a greater degree of control while traversing a side-sloped surface.

Specifically, what is provided is an improved caster and caster system comprising a caster mount attachable to a frame of a mobile device, a caster stem attached to the caster mount and a biasing means for biasing the caster in a desired rotational position. In one embodiment, the biasing means involves having one or more notches defined in the caster stem, and at least one spring plunger, having a ball defined on one end. The ball is biased against the caster stem and situates within the one or more notches to prevent caster drift and flutter and to promote tracking. In this embodiment, an optional disengaging pin can be provided, which slideably engages the one or more notches to disengage the ball from a notch or notches and allow for the free rotation of the caster.

Optionally, magnets located in the caster mount and stem, by using attracting and repelling poles, can also be used to bias the caster stem in a desired location. Other biasing means may also be used.

The caster stem and caster mounts, as modified or retrofitted with the biasing means of the present invention are operable to attach to a standard caster fork and wheel assembly. As such, the improved caster of the present invention is adapted to replace any existing caster on a mobile device.

### BRIEF DESCRIPTION OF THE FIGURES

FIG. 1 shows a prior art caster system wherein, caster drift is shown while the wheelchair traverses a side-sloped surface.

FIG. 2 shows one embodiment of the caster and caster system of the present invention traversing a side-sloped surface without caster drift.

FIG. 3 is a side view of a typical caster system.

FIG. 4A is a top view of one embodiment of the caster stem and caster mount in the caster system of the present invention.

FIG. 4B is a side cut-away view of the caster stem and caster mount along line A-A shown in FIG. 4A.

FIG. 5 is a perspective cut-away view of the caster stem and caster of the present invention shown in FIGS. 4A and 4B.

### DETAILED DESCRIPTION OF THE PREFERRED EMBODIMENT

The invention will now be described in detail in relation to the preferred embodiments and implementation thereof which is exemplary in nature and descriptively specific as disclosed. As is customary, it will be understood that no limitation of the scope of the invention is thereby intended. The invention encompasses such alterations and further modifications in the illustrated apparatus, system or method, and such further applications of the principles of the invention illustrated herein, as would normally occur to persons skilled in the art to which the invention relates.

As an example of one embodiment and not by limitation, this specification discusses use of the caster and caster system on or for a wheelchair, however, the caster and caster system of the present invention is not limited to such. For example, the caster or caster system can be used on a cart, shopping cart, dolly, or any other similar mobile device having wheels capable of similar attachment. The caster and caster system of the present invention also reduces caster or wheel flutter and otherwise promotes tracking in mobile devices.

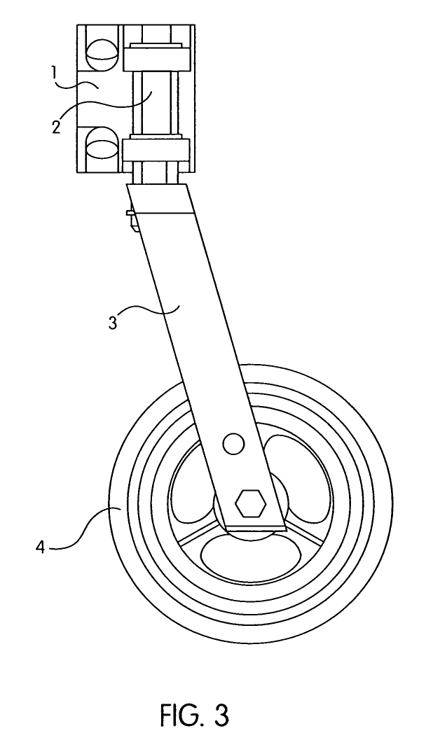

For the purposes of this description, and as shown in FIG. 3, a caster is divided into four main components or assemblies, the caster mount 1, the caster stem 2, the caster fork 3, and the wheel 4. The present invention focuses on a biasing means or hardware that can be retrofitted to an existing caster system or incorporated as improvements to the caster mount 1 and caster stem 2. Once assembled, the caster assembly of the present invention can be installed on any wheelchair, shopping cart, cart, dolly or other mobile device that has or is adaptable for detachable caster mounts.

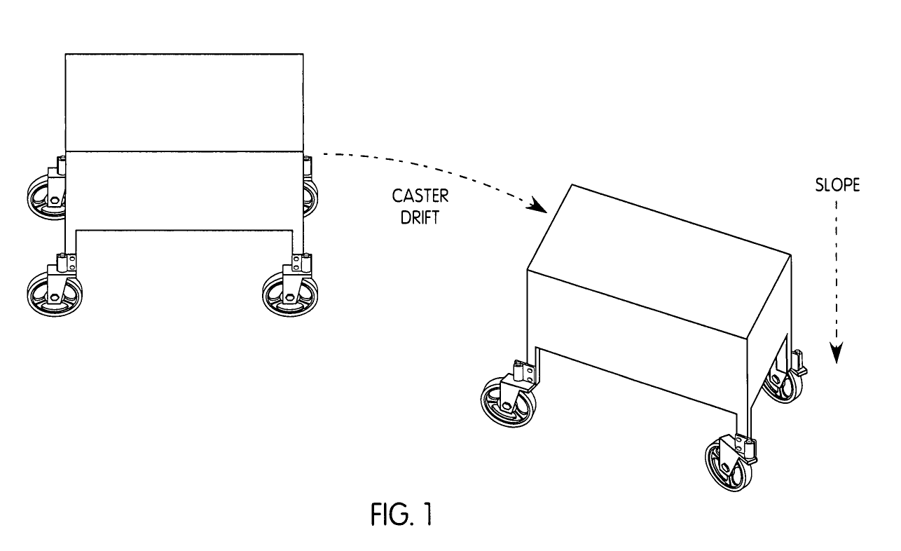

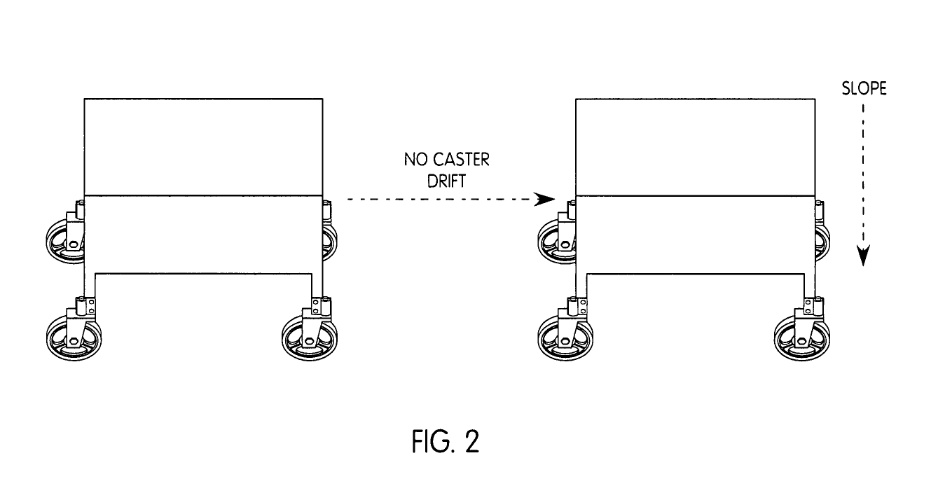

When a wheelchair, shopping cart, cart, dolly or like mobile device traverses a side-sloped surface, the center of mass of the user, cargo, load and/or mobile device, acting about the rear wheels, generates a “moment” on the casters. A “moment” is generally defined as a measure of the torque produced by a force which causes an object to rotate about an axis, which is equal to the force multiplied by the perpendicular distance of the axis from the line of action of the force. This moment causes casters to rotate downhill and causes the mobile device to drift in the same direction (see FIG. 1). As shown in FIG. 2, the caster assembly of the present invention is designed to prevent unwanted caster rotation and/or drift by preferably biasing each caster in the trailing position, that is, when wheel 4 rotates so as to trail behind a mobile device when in motion, and optionally biasing each caster in a leading position (when wheels are facing forward).

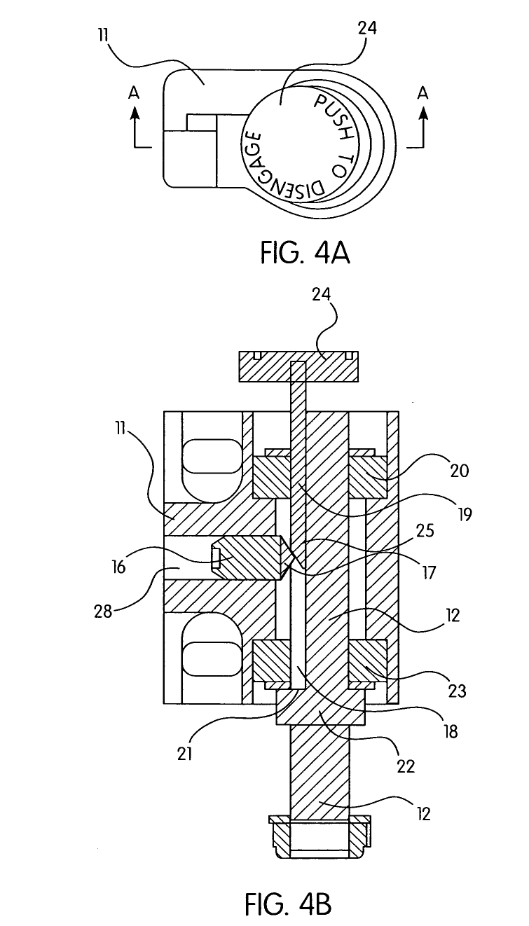

FIGS. 4A and 4B show one embodiment of the caster mount 11 and caster stem 12 of the present invention. The front of the caster mount housing 15 contain a biasing means in that form of at least one ball-nose spring plunger 16. Optionally, the present invention can use two or more spring loaded ball-nose plungers 16 with the number of spring plungers 16 preferably corresponding to an equal number of notches 18 within caster stem 12. However, in other embodiments, multiple plungers 16 may lie within a single notch 18. For purposes of this description, an embodiment with a single plunger 16 is described, but the invention is not limited to this embodiment. The ball 17 of the spring plunger 16 protrudes into the bored center of the housing and interfaces with the notch 18 in the caster stem 12. A spring 26 within the plunger 16 holds ball 17 into the notch 18 and thereby creates a lateral restriction against caster rotation, wobbling and/or drift. Ball 17 can have varying shapes, including a rounded, angled or pointed surface, provided that the shape of ball 17 is operable to interact with notch 18 to provide the desired lateral restriction against caster rotation, wobbling and/or drift.

The interior of the notch 18 (toward the core of the caster stem 12) is cut and/or fabricated to accept ball 17 in such a manner that rotation of stem 12 causes the sides of notch 18 to exert a force on ball 17 and force it backwards into plunger 16. By way of example, but not limitation, notch 18 can be rounded or V-shaped. Other shapes may also be used. The shape and size of the groove can be varied to provide for different levels of resistance to caster rotation and/or flutter.

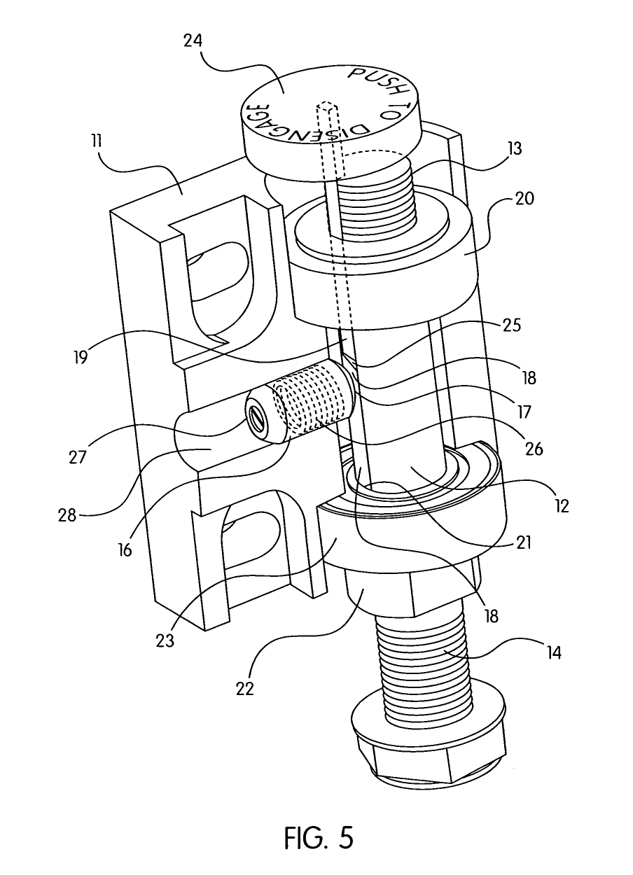

FIG. 5 shows a detailed view of the notch 18 in the caster stem 12. As shown, notch 18 runs lengthwise from about the midpoint 21 of the caster stem 12 and upward to the top of caster stem 12 (i.e., upper thread 13). However, notch 18 can be of a shorter length, so long as it is placed to receive ball 17.

Both of the ends of the caster stem 12 are preferably threaded in one embodiment. The upper thread 13 allows the caster stem 2 to be secured against the bushing 20 in the top of the caster mount 11. The lower thread 14 allows for the attachment of a standard caster fork 3. Just above the lower thread 14, is a bossed, preferably cylindrical section 22. This cylindrical section 22 abuts the bearing 23 in the bottom of the caster mount 11 and serves as an anchor point for attaching the caster fork 3 and for securing the caster stem 12 to the caster mount 11.

In operation, when ball 17 of plunger 16 is fully engaged and caster stem 12 of the present invention begins to rotate, notch 18 in caster stem 12 turns away from ball 17 of the spring plunger 16. As notch 18 initially turns (before full disengagement of ball 17 from notch 18), the surface of the notch 18, opposite the direction of rotation, pushes the ball back towards the spring 26 within the plunger 16. This compresses spring 26 and generates an increased spring force (according to Hooke's Law), which is proportional to the angle of caster stem 12 rotation. The magnitude of the spring force can be adjusted by changing either the strength or stiffness of spring 26 or the position (depth) of the spring plunger 16 within the caster mount housing 11. The latter adjustment can occur, for example, if plunger 16 threadably attaches to cylinder 28 in caster mount 11 and end 27 of plunger 16 is adapted to have a screw head whereby the depth of plunger 16 into notch 18 can be adjusting by screwing plunger 16 inward or outward. Other means of spring adjustment, known to those skilled in the art, are also within scope of the caster and caster system of the present invention. Further, the spring plunger 16 optionally can be replaced with other biasing means known to those skilled in the art.

When ball 17 of spring plunger 16 pushes against the side of the notch 18 upon initial rotation of caster stem 12, the compression force of spring 26 generates a moment about the caster stem 12. This moment increases while ball 17 remains in notch 18 and is forced backward against the spring 26 or other biasing mechanism. This moment or force is opposite in sign to, i.e., resists, the moment generated by the effects of gravity on the center of mass of the user and the wheelchair on a sloped surface. Once the magnitude of the plunger moment matches the magnitude of the moment generated by the center of mass, the caster ceases to rotate. The amount of allowable rotation can be adjusted to meet the request of a specific user or a user's activity. For example, with an increased spring strength and/or increased depth of plunger 16 into notch 18, all caster rotation can be prevented such that the caster and caster system of the present invention serves as a caster lock.

Under normal circumstances, though, the caster and caster system of the present invention allows for at least a minimal amount of rotation to aid in navigation. Where some amount of rotation is intended, the user must overcome the force of the spring 26 or other biasing means that acts to resist caster rotation. In such an embodiment, the ball-nose spring plunger 16 (or other biasing means) is configured to provide just enough force to resist caster drift. By altering the position of the spring plunger 16, the biasing force can be raised or lowered to meet the needs of the user.

Once the caster stem 12 is rotated far enough in either direction, ball 17 exits notch 18, whereby the force of the spring 26 or other biasing means acts directly through the center of the caster stem 12 and no moment is applied to the caster stem 12. This allows the user to turn a mobile device, such as a wheelchair, with only a slight resistance (due to the friction of the ball on the caster stem 12). When a turn is complete and each caster is realigned in the trailing position, the ball 17 reengages the notch 18 in the caster stem 12.

When wheeling indoors or in places where frequent turning is necessary, the forward or rearward bias can be removed from the casters. In the embodiment discussed above, such disengagement can occur by screwing plunger 16 outward so that ball 17 does not rest in notch 18.

In an alternative embodiment of the present invention, disengaging pin 19 (shown in FIGS. 4B and 5) can act to force ball 17 into plunger 16. Disengaging pin 19 fits within notch 18 when it runs the length of stem 12. When push top 24 is pushed downward, the bottom end 25 of disengaging pin 19 disengages the ball 17 of the spring plunger 16 from insertion into notch 18 (i.e., ball 17 is forced into and plunger 16), thereby allowing the caster stem 12 to rotate without lateral restriction and with only limited friction of ball 17 pressing against the outer surface of the caster stem 12. The bottom end 25 of disengaging pin 19 is preferably tapered to gradually push ball 17 of plunger 16 out of and away from notch 18. The push top 24 of the disengaging pin 19 is preferably large, making it easier to handle for users with limited hand function. The top of the disengaging pin 9 can optionally be any other shape or size.

In embodiments with multiple spring plungers 16 and notches 18, a plurality of disengaging pins 19 can be optionally used. The number of disengaging pins 19 is preferably the same as the number of notches 18. Disengaging pin 19 is an optional feature of the present invention, and the caster and caster system of the present invention can function properly with or without the disengaging pin 19.

Other biasing means can also be used, as noted above. For example, in another embodiment, a central rod can run up and down the axle or lie outside the caster stem to create a similar caster bias. This rod interacts with the stem, either directly or indirectly, to prohibit stem rotation when the rod is engaged. Such engagement can occur, for example, when the rod is pushed downward to engage a locking mechanism associated with the rotation of the caster stem.

In yet another embodiment of the present invention, the biasing force can be provided magnetically, e.g., by two sets of magnets. In particular, magnets can be positioned in the caster stem 2 and the caster housing 1 such that attracting poles face each other (e.g. the south pole of the housing magnet faces inward and the north pole of the caster magnet faces outward) and are closest when the caster assembly and wheel rotates toward a desired position (i.e., a trailing or leading position). Two additional magnets can be further positioned in the caster housing 1 on both sides of the initial housing magnet such that like repelling poles face the caster stem 2 (e.g. the north poles of the outer housing magnets face inward). The attraction of the north pole within the caster stem magnet to the south pole in internal magnet of the caster housing and the repulsion of the north pole within the caster magnet to the south poles of the outer magnets in the caster housing 1 act to provide a further bias toward a desired position of the caster assembly and wheel. The strength of the bias is determined by the type, area, and configuration of the magnets in the caster stem 2 and housing 1.

We claim:

1. An improved caster comprising:
a caster mount attachable to a frame of a mobile device;
a caster stem attached to said caster mount and operable to attach to a caster fork and wheel assembly; and
a biasing means operable to restrict the rotation of said caster stem and thereby to prevent caster drift and flutter and to promote tracking of said mobile device.

2. The caster of claim 1, wherein said caster stem has at least one vertical notch defined therein and said biasing means comprises a spring plunger located in said caster mount, said spring plunger having an internal spring and a movable ball member attached to said spring and facing said caster stem whereby said ball is biased against said caster stem and situated within said at least one notch when said caster stem is in a desired rotational position.

3. The caster of claim 2, wherein said the bias of said spring plunger can be adjusted by changing the location of said spring plumber, the strength of said spring or both.

4. The caster of claim 3, wherein the bias of said spring plunger can be adjusted to allow the user of said mobile device to exert force sufficient to overcome said bias and allow for rotation of said caster stem.

5. The caster of claim 2, wherein said caster stem further comprises at least one disengaging pin which slideably engages said at least one notch to disengage the ball from said at least one notch and allow for the free rotation of said caster.

6. The caster of claim 5, wherein said caster further comprises a push top attached to the top of said at least one disengaging pin, said push top operable to allow a user to push said disengaging pin into said notch.

7. The caster of claim 1, wherein said biasing means is comprised of at least one first pair of magnets, with the first magnet of said magnet pair located in said caster housing and the second magnet said magnet pair located in said caster stem such that the magnets are closest to each other when said caster stem is in a desired position and, in such desired position, the adjacent poles of said first and second magnets are opposite in sign and thereby attract each other.

8. The caster of claim 7, wherein said biasing means further comprises at least one additional pair of magnets located in said caster housing such that said at least one additional magnet pair is furthest from said second magnet of said first magnet pair located in said caster stem when said caster stem is in a desired position and, in such desired position, the inner poles of said at least one additional pair of magnets closest to said caster stem are the same in sign to the outer pole of said second magnet of said first magnet pair located in said caster stem and thereby repel each other.

9. The caster of claim 1, wherein said caster is adaptable to replace an existing caster.

10. The caster of claim 1, wherein said biasing means is adaptable to retrofit an existing caster.

11. An improved caster system having a caster stem attached to a caster mount and operable to attach to a caster fork and wheel assembly and a biasing means associated with said caster mount and said caster stem to restrict the rotation of said caster stem and thereby to prevent caster drift and flutter and to promote tracking of a mobile device associated with said caster system, said caster stem having at least one notch defined therein, and said caster mount having a spring plunger mounted within, said spring plunger having an internal spring and a movable ball member attached to said spring and facing said caster stem whereby said ball is biased against said caster stem and situated within said at least one notch when said caster stem is in a desired rotational position.

12. The caster system of claim 11 wherein said the bias of said spring plunger can be adjusted by changing the location of said spring plumber, the strength of said spring or both.

13. The caster system of claim 12, wherein the bias of said spring plunger can be adjusted to allow the user of said mobile device to exert force sufficient to overcome said bias and allow for rotation of said caster stem.

14. The caster system of claim 11, wherein said caster stem further comprises at least one disengaging pin which slideably engages said at least one notch to disengage the ball from said at least one notch and allow for the free rotation of said caster.

15. The caster system of claim 14, wherein said caster further comprises a push top attached to the top of said at least one disengaging pin, said push top operable to allow a user to push said disengaging pin into said notch.

16. The caster system of claim 11, wherein said caster system is adaptable to replace an existing caster.

17. An improved caster system having a caster stem attached to a caster mount and operable to attach to a caster fork and wheel assembly and a biasing means associated with said caster mount and said caster stem to restrict the rotation of said caster stem and thereby to prevent caster drift and flutter and to promote tracking of a mobile device associated with said caster system, wherein said biasing means is comprised of at least one first pair of magnets, with the first magnet of said magnet pair located in said caster housing and the second magnet said magnet pair located in said caster stem such that the magnets are closest to each other when said caster stem is in a desired position and, in such desired position, the adjacent poles of said first and second magnets are opposite in sign and thereby attract each other.

18. The caster system of claim 17, wherein said biasing means further comprises at least one additional pair of magnets located in said caster housing such that said at least one additional magnet pair is furthest from said second magnet of said first magnet pair located in said caster stem when said caster stem is in a desired position and, in such desired position, the inner poles of said at least one additional pair of magnets closest to said caster stem are the same in sign to the outer pole of said second magnet of said first magnet pair located in said caster stem and thereby repel each other.
